(19) United States
(12) Patent Application Publication
(10) Pub. No.: US 2004/0008926 A1
(43) Pub. Date: Jan. 15, 2004

(54) Micromirror switch and transmission method thereof

(75) Inventor: Hung-Yi Lin, Taoyuan County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Walsin Lihwa Corp., Taipei (TW)

(21) Appl. No.: 10/464,958

(22) Filed: Jun. 19, 2003

(30) Foreign Application Priority Data
Jun. 20, 2002 (TW) 091113523

(51) Int. Cl. G02B 6/35

(52) U.S. Cl. 385/18

(57) ABSTRACT

A micromirror switch for implementing a light transmission is provided. The micromirror switch includes a first optical fiber array for transmitting a light ray from a first transmission position thereof, a first micromirror array for receiving the light ray from the first optical fiber array and sending out the light ray switched in a first specific direction, a second micromirror array for receiving the light ray from the first micromirror array and sending out the light ray switched in a second specific direction, and a second optical fiber array for receiving the light array from the second micromirror array and loading the light ray into a second transmission position of the second optical fiber array to complete the light transmission.

### FIELD OF THE INVENTION

This invention relates to a micromirror switch and a transmission method thereof, and more particularly to a light ray switch and a transmission method thereof for a micromirror.

### BACKGROUND OF THE INVENTION

Wireless communication has already affected our life enormously in this century. For realizing a high bandwidth and low cost communication, an optical fiber is utilized to connect among the lands and also the continents more and more. The light transmission already became a significant method for long distance transmission of the internet and the telephone system on the land. And the light has been used as an economic and rapid information carrier. Presently, the core route technology of the internet still employs the electric route, but, following the development of the technology, the methods for signal exchange will all change to be realized by the light. That means the route can be realized directly by the light without transforming the light to the electric signal. The light transmission technology is applied to the advanced MEMS (Micro-Electro-Mechanical System) technology which is developed recently, so that the integrated technology is now called MOEMS (Micro-Optical-Electro-Mechanical System).

Nowadays, the researchers have proposed several concepts of the light switch and, among these, most are realized by a removable micromirror array. The micromirror array can be a single axis switch of a light ray for communicating and also can be used as a double axis for re-orientating the light ray which came from any direction. FIG. 1A illustrates a schematic view of the internal structure of a multiport light switch according to the prior art. An optical fiber 11 transmits the light ray to pass through a lens array 12, and a micromirror array 14 having the micromirror 13 therein rotated around the two axis will repeatedly reflect the light ray for changing the incident direction of the light ray. As shown in FIG. 1B, it illustrates a detailed structure of the removable mirror structure shown in FIG. 1A according to the prior art.

As described above, it only shows the simply directional alteration of the light ray. If it needs to exchange the position of the light ray, two removable micromirror arrays will be used to orientate the light ray. Please refer to FIG. 2 illustrating a schematic view of the internal structure in a conventional multiport light switch. Firstly, a transmission position (as (X₄, Y₁) shown in FIG. 2) is selected from the first optical fiber array 21, the first micromirror array 23 and the second micromirror array 24 will then repeatedly receive the light ray from the transmission position (X₄, Y₁) and then send it to an assigned transmission position (as (X₄, Y₁) shown in FIG. 2) of the second optical fiber array 22. The disadvantage of this method is that it is uneasy to control and may it is easy to couple the light because the micromirrors have to rotate around the XY axis simultaneously in both the micromirror arrays. Furthermore, it might cause the loss of the light ray through multiple reflections.

Because of the technical defects described above, the applicant keeps on carving unflaggingly to develop a “micromirror switch and transmission method thereof” through wholehearted experience and research.

### SUMMARY OF THE INVENTION

It is an object of the present invention to provide a micromirror switch and a transmission method thereof which can implement the parallel translation of the transmission position with least reflection time to complete the light transmission.

According to an aspect of the present invention, a micromirror switch for implementing a light transmission includes a first optical fiber array for transmitting a light ray from a first transmission position thereof, a first micromirror array for receiving the light ray from the first optical fiber array and sending out the light ray switched in a first specific direction, a second micromirror array for receiving the light ray from the first micromirror array and sending out the light ray switched in a second specific direction, and a second optical fiber array for receiving the light array from the second micromirror array and loading the light ray into a second transmission position of the second optical fiber array to complete the light transmission.

Preferably, the first transmission position is specific XY coordinates.

Preferably, the first specific direction is a horizontal direction.

Certainly, the horizontal direction can be an X-axis direction.

Preferably, the first micromirror array comprises two micromirror arrays.

Certainly, the two micromirror arrays can be perpendicular to each other.

Preferably, the second transmission position is specific XY coordinates.

Preferably, the second specific direction is a perpendicular direction.

Certainly, the perpendicular direction is a Y-axis direction.

Preferably, the second micromirror array comprises two micromirror arrays.

Certainly, the two micromirror arrays can be perpendicular to each other.

Preferably, the switch motion of the light ray is to switch a transmission position of the light ray.

In accordance with another aspect of the present invention, a transmission method applied to a micromirror switch for implementing a light transmission, wherein the micromirror switch having a first optical fiber array, a first micromirror array, a second micromirror array, and a second optical fiber array, includes steps of transmitting the light ray from a first transmission position of the first optical fiber array by the first optical fiber array, receiving the light ray transmitted from the first optical fiber array by the first micromirror array and sending out the light ray switched in a first specific direction, receiving the light ray transmitted from the first micromirror array by the second micromirror array and sending out the light ray switched in a second specific direction, and receiving the light ray transmitted from the second micromirror array by the second optical fiber array and loading the light ray into a second position of the second optical fiber array for completing the light transmission.

Preferably, the first transmission position is a XY coordinates.

Preferably, the first specific direction is a horizontal direction.

Certainly, the horizontal direction can be an X-axis direction.

Preferably, the first micromirror array comprises two micromirror arrays.

Certainly, the two micromirror arrays can be perpendicular to each other.

Preferably, the second transmission position is specific XY coordinates.

Preferably, the second specific direction is a perpendicular direction.

Certainly, the perpendicular direction can be a Y-axis direction.

Preferably, the second micromirror array comprises two micromirror arrays.

Certainly, the two micromirror arrays can be perpendicular to each other.

Preferably, the switch motion of the light ray is to switch a transmission position of the light ray.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1A is a schematic view of the internal structure of a multiport light switch according to the prior art;

FIG. 1B is a detailed structure of a removable mirror shown in FIG. 1A according to the prior art;

FIG. 2 is a schematic view of the internal structure of a multiport light switch according to the prior art; and

FIGS. 3A˜3B are schematic structure views of a preferred embodiment which is developed from a 4N micromirror switch.

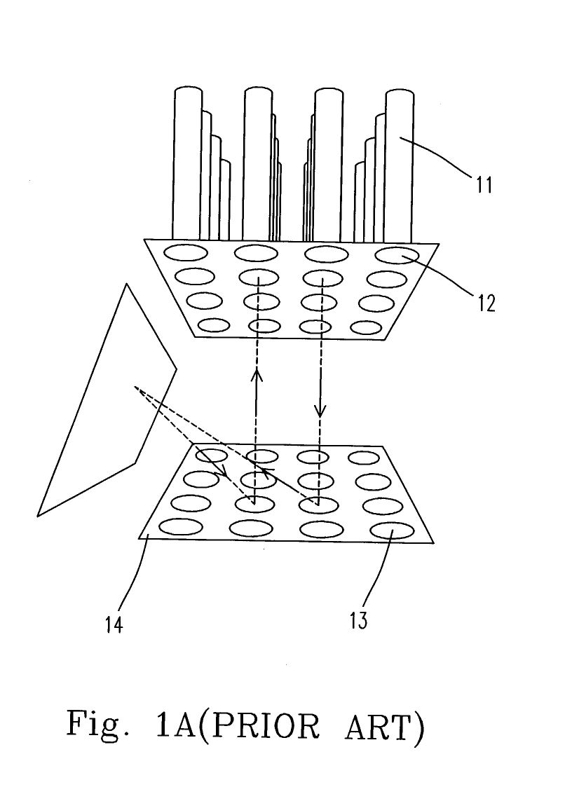

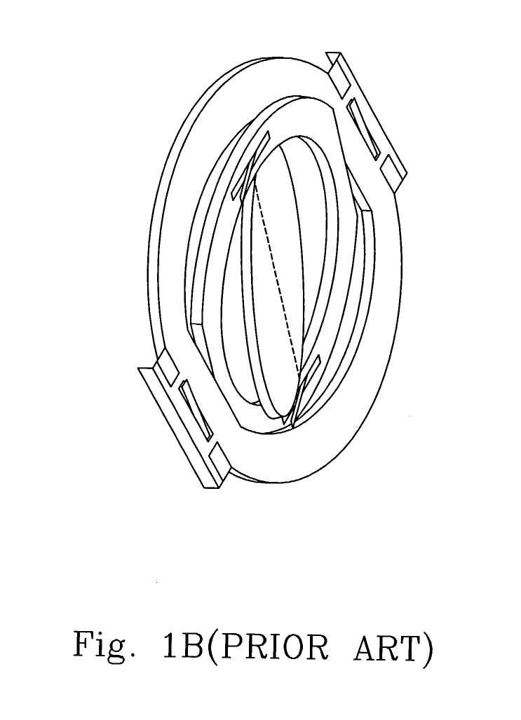

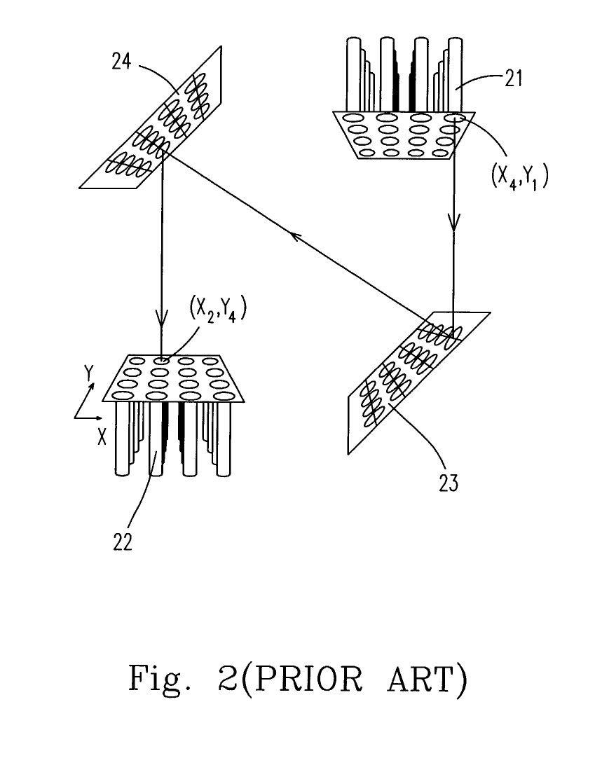

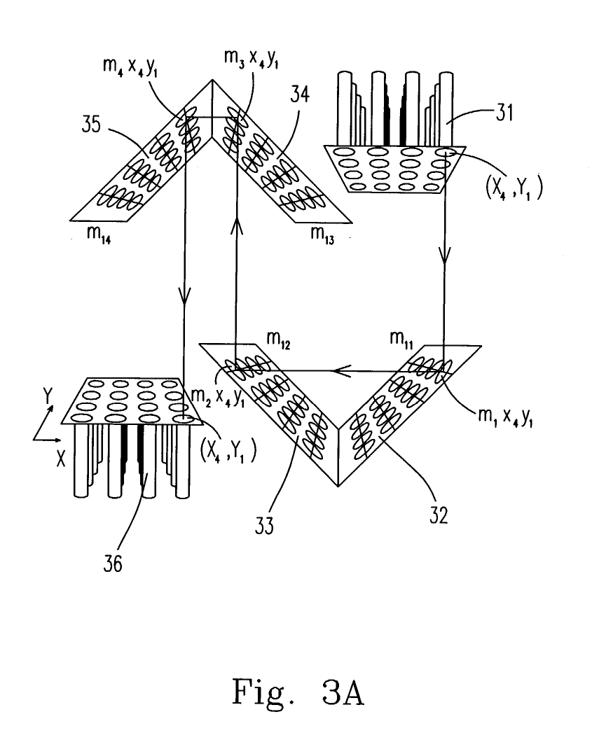

### DETAILED DESCRIPTION OF THE PREFERRED EMBODIMENT

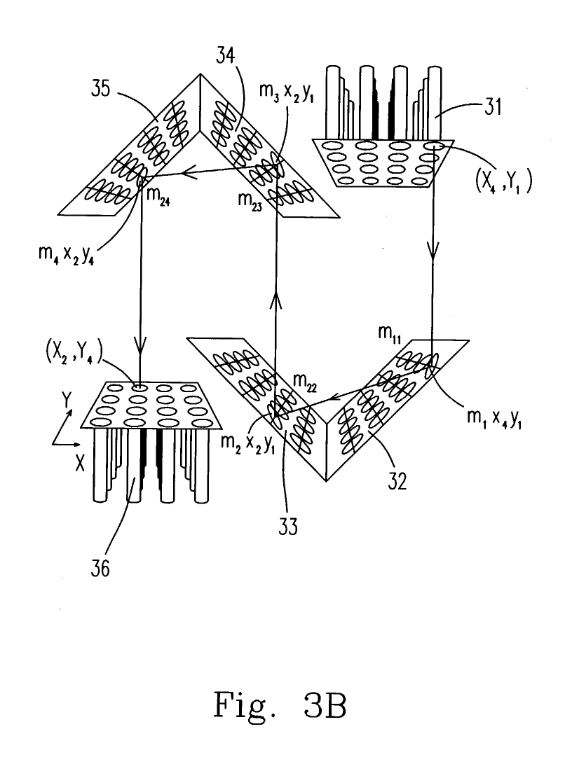

Please refer to FIGS. 3A˜3B illustrating schematic structure views of a preferred embodiment which is developed from a 4N micromirror switch for completing a switch motion of a light ray. The structure includes a first optical fiber array 31, a first micromirror array 32 and 33, a second micromirror array 34 and 35, and a second optical fiber array 36. The first micromirror array 32 and 33 is constituted by a first horizontal controlling micromirror array 32 and a second horizontal controlling micromirror array 33. The second micromirror array 34 and 35 is constituted by a first perpendicular controlling micromirror array 32 and a second perpendicular controlling micromirror array 33. The first horizontal controlling micromirror array 32 and the second horizontal controlling micromirror array 33 are perpendicular to each other. And, the first perpendicular controlling micromirror array 34 and the second perpendicular controlling micromirror array 35 are perpendicular to each other. By the arrangement described above, the light ray can be translated for reducing the loss of the light ray which is caused by the multiple reflections.

There are two main practices of the present invention described as follows:

1. The transmission positions in the optical fiber arrays are identical (as shown in FIG. 3A, the light ray is transmitted from a coordinates (X₄, Y₁) in the first optical fiber array to a coordinates (X₄, Y1) in the second optical fiber array):

Firstly, an optical fiber in the first optical fiber array is selected for performing the transmission action and defined as the coordinates (X₄, Y₁). Secondly, the light ray from the optical fiber is transmitted to a micromirror m₁x₄y₁ in the first horizontal controlling micromirror array 32 and then is sent out to a micromirror m₂x₄y₁ in the second horizontal controlling micromirror array 33 to complete the movement of the light ray in the X-axis direction. Then, the light ray from the micromirror m₂x₄y₁ is transmitted to a micromirror m₃x₄y₁ in the first perpendicular controlling micromirror array 34 and then is sent out to a micromirror m₄x₄y₁ in the second perpendicular controlling micromirror array 35 to complete the movement of the light ray in the Y-axis direction. Finally, the light ray is transmitted to the coordinates (X4, Y1) in the second optical fiber array by the micromirror m₄x₄y₁. Because the first and the second horizontal controlling micromirror arrays and the first and the second perpendicular controlling micromirror arrays are all perpendicular to each other, the transmission position will not be altered if the micromirrors therein are not rotated.

2. The transmission positions in the optical fiber arrays are different (as shown in FIG. 3B, the light ray is transmitted from a coordinates (X₄, Y₁) in the first optical fiber array to a coordinates (X₂, Y₄) in the second optical fiber array):

Firstly, an optical fiber in the first optical fiber array is selected for performing the transmission action and defined as the coordinates (X₄, Y₁). Secondly, the light ray from the optical fiber is transmitted to a micromirror m1x4y1 in the first horizontal controlling micromirror array 32 and then is sent out to a micromirror m₂x₂y₁ in the second horizontal controlling micromirror array 33 by adjusting a tilt angle of the micromirror m₁x₄y₁, namely increasing the incident angle of the light ray, for reducing the movement distance of the light ray in the X-axis direction (e.g., X₄-->X₂). Then, the light ray from the micromirror m₂x₂y₁ is transmitted to a micromirror m₃x₂y₄ in the first perpendicular controlling micromirror array 34 by adjusting the tilt angle of the micromirror m₂x₂y₁ and then is sent out to a micromirror m₄x₂y₄ in the second perpendicular controlling micromirror array 35 by adjusting the tilt angle of the micromirror m₃x₂y₄ for reducing the movement distance of the light ray in the Y-axis direction (e.g., Y₁-->Y₄). Finally, the light ray is transmitted to the coordinates (X₂, Y₄) in the second optical fiber array by adjusting the tilt angle of the micromirror m₄x₂y₄.

It is clear that if we want to alter the X-axis position of the optical fiber array, the X coordinates of the first and the second horizontal controlling micromirror arrays will be correspondingly changed. On the contrary, if we want to alter the Y-axis position of the optical fiber array, the Y coordinates of the first and the second perpendicular controlling micromirror arrays will be correspondingly changed, too.

In view of the aforesaid, the micromirror switch and the exchange method thereof according to the present invention can improve the disadvantages of the conventional technology. The conventional technology needs to move the positions of the XY axis of the two micromirror arrays simultaneously which can not be controlled easily, may couple the light, and also cause the loss of the light ray because of the multiple reflections. Thus, the present invention can economize the labor power and the time. Consequently, the present invention conforms to the demand of the industry and is industrial valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A micromirror switch for implementing a light transmission comprising:
a first optical fiber array for transmitting a light ray from a first transmission position thereof;
a first micromirror array for receiving said light ray from said first optical fiber array and sending out said light ray switched in a first specific direction;
a second micromirror array for receiving said light ray from said first micromirror array and sending out said light ray switched in a second specific direction; and
a second optical fiber array for receiving said light array from said second micromirror array and loading said light ray into a second transmission position of said second optical fiber array to complete said light transmission.

2. A switch according to claim 1 wherein said first transmission position is specific XY coordinates.

3. A switch according to claim 1 wherein said first specific direction is a horizontal direction.

4. A switch according to claim 3 wherein said horizontal direction is an X-axis direction.

5. A switch according to claim 1 wherein said first micromirror array comprises two micromirror arrays.

6. A switch according to claim 5 wherein said two micromirror arrays are perpendicular to each other.

7. A switch according to claim 1 wherein said second transmission position is specific XY coordinates.

8. A switch according to claim 1 wherein said second specific direction is a perpendicular direction.

9. A switch according to claim 8 wherein said perpendicular direction is a Y-axis direction.

10. A switch according to claim 1 wherein said second micromirror array comprises two micromirror arrays.

11. A switch according to claim 10 wherein said two micromirror arrays are perpendicular to each other.

12. A switch according to claim 1 wherein said switch motion of said light ray is to switch a transmission position of said light ray.

13. An exchange method applied to a micromirror switch for implementing a light transmission, wherein said micromirror switch having a first optical fiber array, a first micromirror array, a second micromirror array, and a second optical fiber array, comprising steps of:
transmitting a light ray from a first transmission position of said first optical fiber array by said first optical fiber array;
receiving said light ray transmitted from said first optical fiber array by said first micromirror array and sending out said light ray switched in a first specific direction;
receiving said light ray transmitted from said first micromirror array by said second micromirror array and sending out said light ray switched in a second specific direction; and
receiving said light ray transmitted from said second micromirror array by said second optical fiber array and loading said light ray into a second position of said second optical fiber array for completing said light transmission.

14. A method according to claim 14 wherein said first transmission position is a XY coordinates.

15. A method according to claim 14 wherein said first specific direction is a horizontal direction.

16. A method according to claim 15 wherein said horizontal direction is an X-axis direction.

17. A method according to claim 14 wherein said first micromirror array comprises two micromirror arrays.

18. A method according to claim 17 wherein said two micromirror arrays are perpendicular to each other.

19. A method according to claim 14 wherein said second transmission position is specific XY coordinates.

20. A method according to claim 14 wherein said second specific direction is a perpendicular direction.

21. A method according to claim 20 wherein said perpendicular direction is a Y-axis direction.

22. A method according to claim 14 wherein said second micromirror array comprises two micromirror arrays.

23. A method according to claim 22 wherein said two micromirror arrays are perpendicular to each other.

24. A method according to claim 14 wherein said switch motion of said light ray is to switch a transmission position of said light ray.
